(19) United States
(12) Patent Application Publication
(10) Pub. No.: US 2008/0037248 A1
(43) Pub. Date: Feb. 14, 2008

(54) OPTICAL MEMBER, BACK LIGHT ASSEMBLY AND DISPLAY APPARATUS HAVING THE SAME, AND METHOD OF MANUFACTURING THE BACKLIGHT ASSEMBLY

(75) Inventors: Se-Ki PARK, Suwon-si (KR); Gi-Cherl KIM, Yongin-si (KR); Sung-Wook KANG, Seoul (KR)

Correspondence Address: CANTOR COLBURN, LLP, 55 GRIFFIN ROAD SOUTH, BLOOMFIELD, CT, 06002, US

(73) Assignee: Samsung Electronics Co., Ltd., Suwon-si (KR)

(21) Appl. No.: 11/838,412

(22) Filed: Aug. 14, 2007

(30) Foreign Application Priority Data
Aug. 14, 2006 (KR) 10-2006-076831

(51) Int. Cl. F21V 11/00

(52) U.S. Cl. 362/235; 362/311; 362/355

(57) ABSTRACT

An optical member is provided and includes a bottom surface upon which light is incident from an outside source. The optical member also includes a top surface, facing the bottom surface, from which the incident light through the bottom surface exits. The optical member further includes a plurality of light controllers formed between the bottom surface and the top surface by removing portions of the optical member to mix and diffuse the incident light.

This application claims priority to Korean Patent Application No. 2006-76831, filed on Aug. 14, 2006, and all the benefits accruing therefrom under 35 U.S.C. §119, the contents of which are herein incorporated by reference in its entirety.

### BACKGROUND OF THE INVENTION

1. Field of the Invention

The present invention relates to an optical member, a back light assembly and a display apparatus having the same, and a method of manufacturing the backlight assembly. More particularly, the present invention relates to an optical member capable of improving a display characteristic, a back light assembly and a display apparatus having the same, and a method of manufacturing the backlight assembly.

2. Description of the Related Art

In general, a display apparatus displays an image by changing data having an electrical format processed by an information processing apparatus such that the image can be seen to the naked eye. A liquid crystal display (“LCD”), as one of the display apparatuses, displays an image using electrical and optical characteristics of liquid crystal such as light-weight, thin thickness, low driving voltage, and low power consumption.

In detail, the LCD includes an LCD panel in which liquid crystal is interposed between a lower substrate and an upper substrate in order to display an image. Since the LCD panel is a non-emissive device that does not emit light, the LCD further includes an additional back light assembly so as to supply light to the LCD panel.

A backlight assembly mainly uses a light source that generates white light such as a cold cathode fluorescent lamp (“CCFL”) and a flat fluorescent lamp (“FFL”). However, recently, in order to reduce power consumption and improve color reproducibility, a back light assembly that realizes white light using red, green, and blue light emitting diodes as light sources has been researched and developed. The back light assembly further includes a diffusion plate in order to diffuse and mix the monochromatic light components output from the red, green, and blue light emitting diodes. The diffusion plate includes a diffusion agent, such as a bead that diffuses light, and mixes the monochromatic light components from the red, green, and blue light emitting diodes with each other to emit white light.

However, since the uniformity of color and brightness deteriorates when the monochromatic light components are mixed with each other using only the diffusion plate, the display characteristic of the LCD also deteriorates. As a result, an additional diffusion sheet that improves the uniformity of color and brightness becomes necessary.

### BRIEF SUMMARY OF THE INVENTION

An exemplary embodiment of the present invention includes an optical member capable of diffusing incident light to improve uniformity of color and brightness.

Another exemplary embodiment of the present invention includes a backlight assembly having the optical member.

A further exemplary embodiment of the present invention includes a display apparatus including the backlight assembly.

In one aspect of the present invention, the optical member includes a bottom surface, a top surface, and a plurality of light controllers.

Light is incident onto the bottom surface from an outside source. The top surface faces the bottom surface and the light incident through the bottom surface is output through the top surface. The light controllers are formed by removing portions of the optical member. The light controllers mix and diffuse incident light. The incident light may include two or more colors.

The light controllers may define holes formed through the bottom surface and the top surface. The light controllers refract the incident light to change a path of the incident light.

A ratio of a length of each light controller to a thickness of the optical member is from about 0.7:1 to about 1:1, and a ratio of a width of each light controller to the thickness of the optical member is from about 0.15 to about 1.

A number of the light controllers may be disposed on the bottom surface of the optical member to form a square shape pattern, a diamond shape pattern, a pentagonal shape pattern and/or a hexagonal shape pattern.

The optical member may include a diffusing pattern, a plurality of beads, and/or a plurality of voids to diffuse the incident light.

In another aspect of the present invention, a backlight assembly includes a light generator and an optical member.

The light generator generates light. The optical member is positioned above the light generator and includes a plurality of light controllers formed between a bottom surface and a top surface of the optical member by removing portions of the optical member to mix and diffuse incident light.

The light generator includes a plurality of light sources that emit red, green, and blue light components. The light sources are divided into a plurality of light source groups separated from each other by a predetermined distance. Each of the light source groups includes at least one light source emitting the red light, at least one light source emitting the green light, and at least one light source emitting the blue light.

The light controllers, when viewed in a plan view, are positioned at a peripheral region of the light source groups. The light sources include light emitting diodes (“LEDs”).

In still another aspect of the present invention, a display apparatus includes a backlight assembly and a display panel.

The backlight assembly includes a light generator generating light and an optical member disposed above the light generator. The optical member includes a plurality of light controllers formed between a bottom surface and a top surface of the optical member by removing portions of the optical member to mix and diffuse the light from the light generator. The display panel is provided above the optical member to display an image using diffused light from the optical member.

In yet a further aspect of the present invention, a method of manufacturing a backlight assembly is disclosed. The method includes forming an optical member having a bottom surface upon which light is incident and a top surface facing the bottom surface from which the incident light through the bottom surface exits. The method further includes disposing the optical member above a light generator, the light generator generating the light. The method also includes forming a plurality of light controllers between the bottom surface and top surface by removing portions of the optical member to mix and diffuse the light.

The formation of a plurality of light controllers may include defining holes through the bottom surface and the top surface, the light controllers refracting the incident light to change a path of the incident light.

A ratio of a length of each light controller to a thickness of the optical member is from about 0.7:1 to about 1:1, and a ratio of a width of each light controller to the thickness of the optical member is from about 0.15 to about 1.

The light generator may include a plurality of light sources that emit red, green, and blue light components. The method may further include disposing the light controllers at a peripheral region of the light sources.

According to the above, since the light controllers are formed by removing portions of the optical member, a light loss factor is reduced. Also, the light controllers refract the light emitted from the light generator to mix and diffuse the light. Thus, the backlight assembly can improve the bright uniformity and the color uniformity and provide light having high brightness, so that the display characteristic of the display apparatus is improved.

### BRIEF DESCRIPTION OF THE DRAWINGS

The above and other aspects, features and advantages of the present invention will become readily apparent with reference to the following detailed description when considered in conjunction with the accompanying drawings wherein:

FIG. 1 is a perspective view illustrating an exemplary embodiment of an optical member according to the present invention;

FIG. 2 is a cross-sectional view of the optical member of FIG. 1 taken along a line I-I′;

FIG. 3 is an enlarged cross-sectional view of a part ‘A’ shown in FIG. 2;

FIG. 4A is a simulation view illustrating a brightness distribution of a conventional optical sheet;

FIGS. 4B to 4F are simulation views illustrating brightness distribution of the optical member shown in FIG. 1;

FIGS. 5A to 5C are simulation views illustrating brightness distribution of the optical member of FIG. 1 in accordance with the depth of a groove;

FIG. 6 is a cross-sectional view illustrating another exemplary embodiment of light controllers for the optical member of FIG. 1;

FIGS. 7A to 7D are plan views illustrating alignment patterns of light controllers shown in FIG. 1;

FIG. 8 is an exploded perspective view illustrating an exemplary embodiment of a back light assembly according to the present invention;

FIG. 9 is a plan view illustrating the back light assembly of FIG. 8;

FIG. 10 is a cross-sectional view of the backlight assembly shown in FIG. 8 taken along a line II-II′;

FIG. 11A is a simulation view illustrating brightness intensity of a conventional optical sheet;

FIG. 11B is a simulation view illustrating brightness intensity of the optical member shown in FIG. 7;

FIG. 12 is a graph illustrating brightness distribution of the light sources shown in FIG. 8; and

FIG. 13 is an exploded perspective view showing an exemplary embodiment of a liquid crystal display (“LCD”) according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Hereinafter, the present invention will be explained in detail with reference to the accompanying drawings.

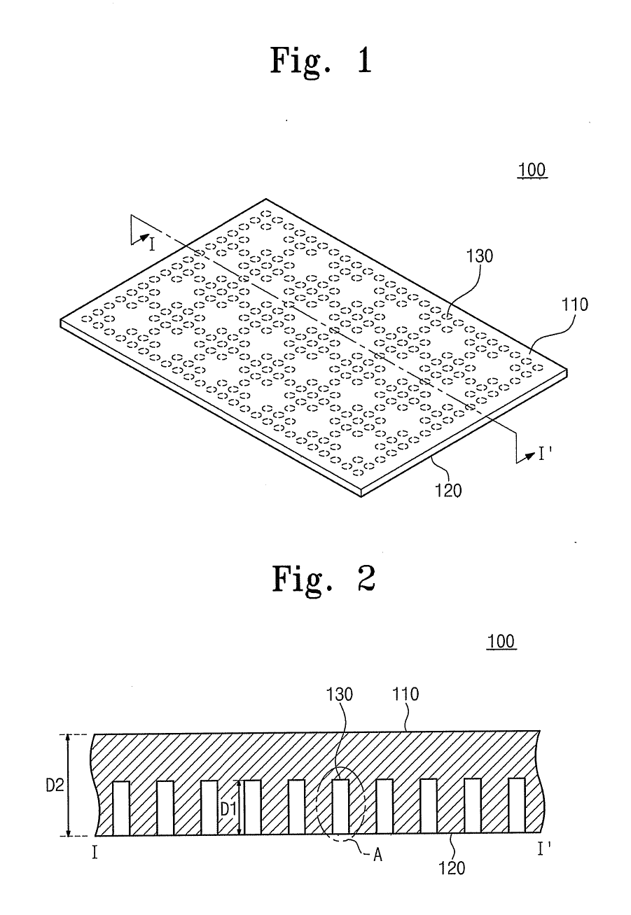

FIG. 1 is a perspective view illustrating an optical member according to an exemplary embodiment of the present invention, and FIG. 2 is a cross-sectional view of the optical member of FIG. 1 taken along a line I-I′.

Referring to FIGS. 1 and 2, an optical member 100 diffuses incident light provided from an outside source and may have a plate-like shape. The optical member 100 may include a resin material, for example, polycarbonate (“PC”) or polymethylmethacrylate (“PMMA”).

In detail, the optical member 100 includes a top surface 110, a bottom surface 120 that faces the top surface 110, and a plurality of light controllers 130 mixing and diffusing the incident light.

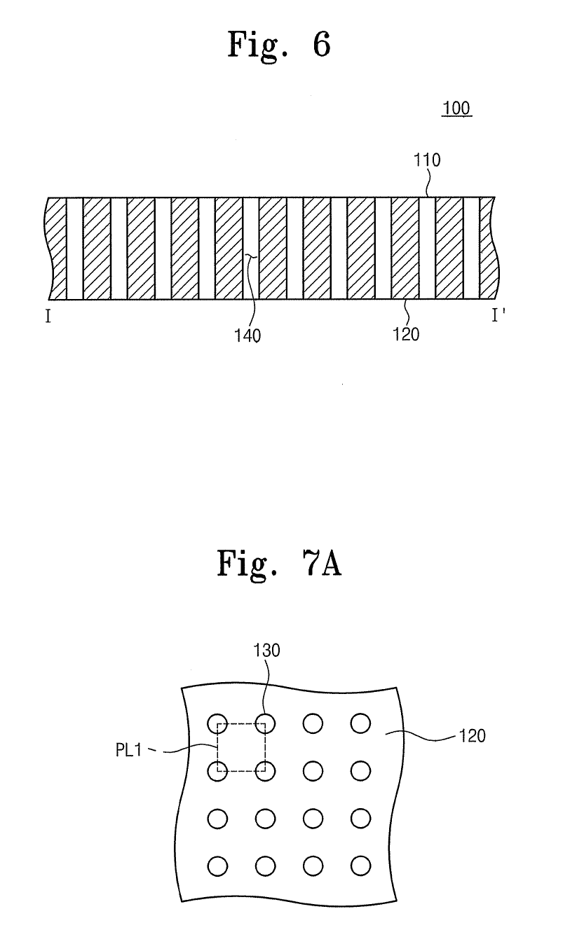

The light incident through the bottom surface 120 is output through the top surface 110, which surface 110 receives the incident light. The light controllers 130 may be formed between the ton surface 110 and the bottom surface 120 by removing portions of the bottom surface 120 to mix and diffuse the incident light (as shown in FIG. 2). Alternatively, the light controllers 130 may be formed between the top surface 110 and the bottom surface 120 by removing portions of both the top surface 110 and the bottom surface 120 to mix and diffuse the incident light (as shown in FIG. 6). The incident light may have two or more colors.

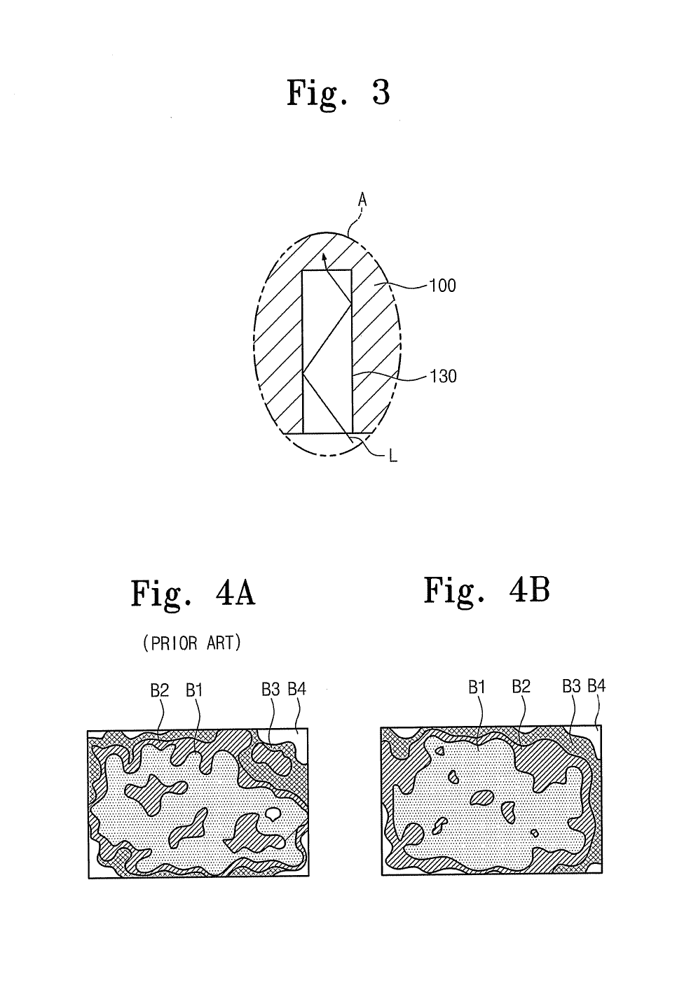

FIG. 3 is an enlarged cross-sectional view of a portion ‘A’ shown in FIG. 2.

Referring to FIGS. 2 and 3, the light controllers 130 are separated from each other by a predetermined distance.

In an exemplary embodiment, the light controllers 130 define grooves which are formed between the top surface 110 and the bottom surface 120 by removing portions of the optical member 100 from the bottom surface 120 by a predetermined depth “D1”, where “D2” is the depth of the optical member 100.

In the present embodiment, the grooves may have column-shaped sections or semi-circular sections. However, it will be understood that other shaped sections may be employed for the grooves.

The light controllers 130 change the path of the incident light L to mix the light. That is, the light controllers 130 refract the incident light L to change the path thereof. As a result, the monochromatic light components that constitute the incident light L are uniformly mixed with each other, thereby improving the color uniformity and the brightness uniformity of the light output from the top surface 110.

Hereinafter, brightness distributions of a conventional optical sheet and the exemplary optical member 100 of FIG. 1 will be explained with reference to the drawings.

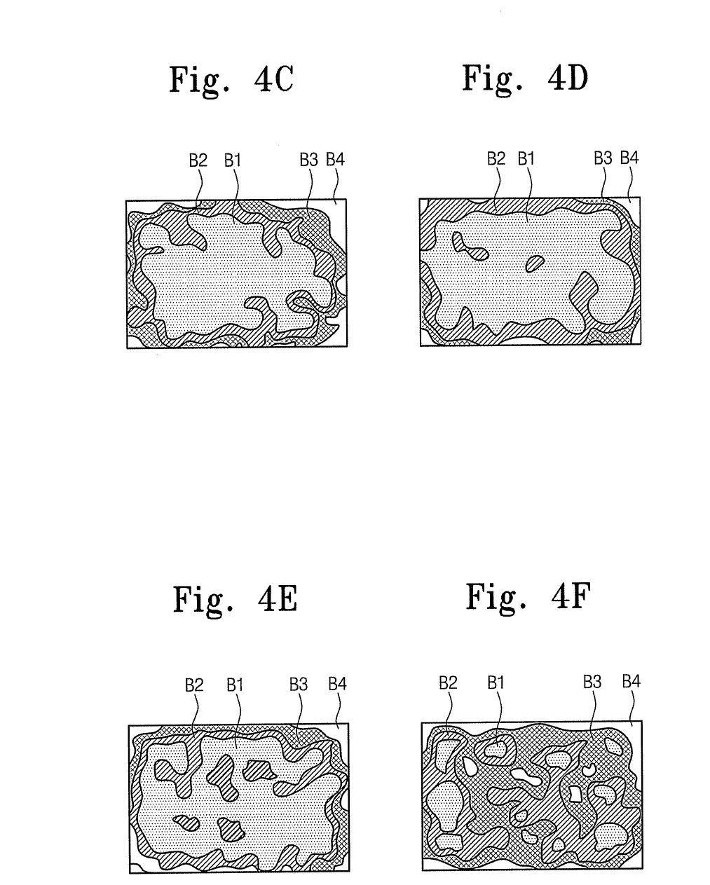

FIG. 4A is a simulation view illustrating brightness distribution of a conventional optical sheet, and FIGS. 4B to 4F are simulation views illustrating brightness distribution of the optical member shown in FIG. 1.

Referring to FIGS. 2 and 4A to 4F, the conventional optical sheet and the optical member 100 are divided into first, second, third, and fourth brightness regions B1, B2, B3, and B4 in accordance with a brightness value thereof. Here, the brightness value is gradually reduced from the first brightness region B1 to the fourth brightness region B4.

FIG. 4A is a simulation view illustrating the brightness distribution of the conventional optical sheet, and FIGS. 4B to 4F are simulation views illustrating changes in brightness based upon varying widths of the grooves of the light controllers 130; that is, the diameter of the grooves. Here, the thickness of each of the conventional optical sheet and the optical member 100 is about 2 mm, and the distance between the conventional optical sheet and a light source providing the light is identical to the distance between the optical member 100 and the light source. The lengths of the grooves corresponding to the simulation views may be the same.

The diameters of the grooves corresponding to the simulation views are as follows. In FIG. 4B, the diameter of the grooves is about 0.1 mm. In FIG. 4C, the diameter of the grooves is about 0:2 mm. In FIG. 4D, the diameter of the grooves is about 0.3 mm. In FIG. 4E, the diameter of the grooves is about 0.4 mm. In FIG. 4F, the diameter of the grooves is about 0.5 mm.

When the simulation view of the conventional optical sheet of FIG. 4A is compared with the simulation view of the optical member 100 of FIG. 4B, the brightness distribution of the optical member 100 including the grooves having the diameter of about 0.1 mm is more uniform than that of the conventional optical sheet. In addition, the first brightness region B1 having the higher brightness is widely formed in the optical member 100 than that of the conventional optical sheet. That is, since the optical member 100 can mix a greater amount of incident light than that of the conventional optical sheet, the brightness uniformity of the optical member 100 is improved, thereby improving the overall brightness.

When the simulation view of FIG. 4B is compared with the simulation views of FIGS. 4C and 4D, the brightness distribution of the optical member 100 is more uniform when the diameter of the grooves is about 0.2 mm than when the diameter of the grooves is about 0.1 mm. The brightness distribution of the optical member 100 is more uniform when the diameter of the grooves is about 0.3 mm than when the diameter of the grooves is about 0.2 mm. The first brightness region B1 is widely formed when the diameter of the grooves is about 0.3 mm than when the diameter of the grooves is about 0.2 mm.

By contrast, when the simulation view of FIG. 4D is compared with the simulation views of FIGS. 4E and 4F, the brightness uniformity of the optical member 100 becomes lowered when the diameters of the grooves are about 0.4 mm and about 0.5 mm than when the diameter of the grooves is about 0.3 mm. The first brightness region B1 of the optical member 100 is narrowly formed when the diameters of the grooves are about 0.4 mm and about 0.5 mm than when the diameter of the grooves is about 0.3 mm. That is, when the diameter of the grooves is larger than a predetermined reference value (e.g., 0.3 mm), the loss factor of the incident light increases. As a result, the brightness is reduced and the brightness distribution is non-uniform.

The grooves defined by the light controllers 130 should maintain appropriate diameters capable of improving the brightness uniformity of the optical member 100. The appropriate diameters of the grooves may be determined in accordance with the material and thickness of the optical member 100, as well as the sizes of the grooves.

Referring again to FIG. 2, the depth D1 of the grooves is smaller than the thickness D2 of the optical member 100 and varies depending on the material and thickness D2 of the optical member 100. In particular, since the light transmittance of the optical member 100 varies according to the depth D1 of the grooves, the brightness distribution varies.

Hereinafter, changes in brightness of the optical member 100 in accordance with the depth D1 of the grooves will be described in detail with reference to simulation views.

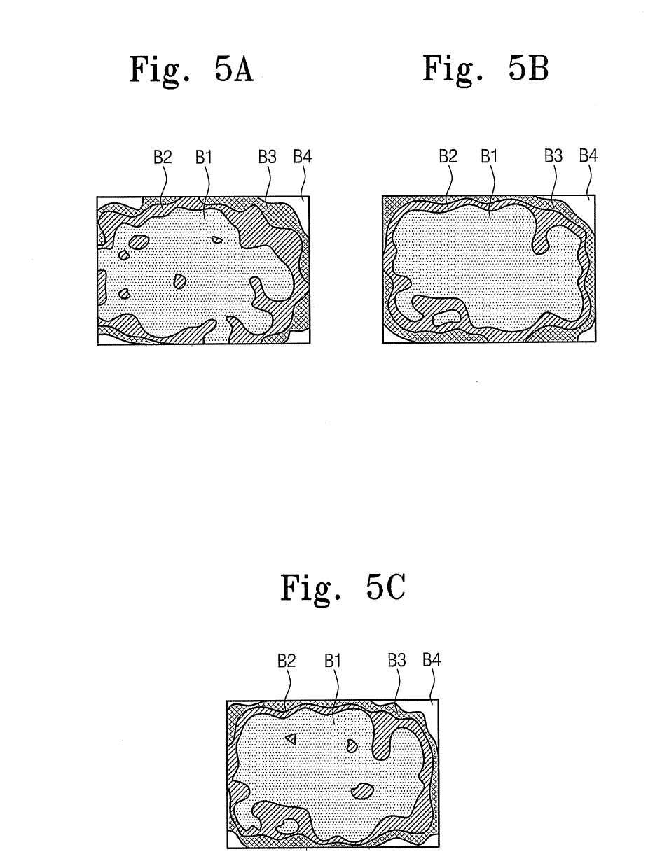

FIGS. 5A to 5C are simulation views illustrating brightness distribution of the optical member 100 shown in FIG. 1 in accordance with the depths of the grooves. In FIGS. 5A to 5C, the conditions except for the depth D1 of the grooves (for example, the diameters of the grooves) are the same.

FIG. 5A illustrates the brightness distribution when the depth D1 of the grooves is about 0.2 mm, FIG. 5B illustrates the brightness distribution when the depth D1 of the grooves is about 1.4 mm, and FIG. 5C illustrates the brightness distribution when the depth D1 of the grooves is about 1.8 mm.

Regarding the brightness distribution of the optical member 100 in accordance with the changes in the depth D1 of the grooves, the optical member 100 exhibits the most uniform brightness distribution when the depth D1 of the grooves is about 1.4 mm (as shown in FIG. 5B). That is, when the depth D1 of the grooves is smaller than a predetermined length, the transmittance of the incident light and the diffusivity of light are reduced so that the brightness uniformity of the optical member 100 deteriorates. On the other hand, when the depth D1 of the grooves is larger than a predetermined length, the loss factor of the incident light increases so that the brightness uniformity of the optical member 100 is reduced and then the entire brightness is also reduced.

Therefore, the grooves defined by the light controllers 130 must maintain the proper depth D1. The proper depth D1 of the grooves may be determined in accordance with the material and thickness of the optical member 100 and the diameter of the grooves.

FIG. 6 is a cross-sectional view illustrating another exemplary embodiment of light controllers associated with the optical member shown in FIG. 1.

Referring to FIG. 6, light controllers 140 define the holes formed through both the top surface 110 and the bottom surface 120 of the optical member 100. The light controllers 140 refract the incident light to change the path thereof. As a result, the monochromatic light components that constitute the incident light are uniformly mixed with each other. In the exemplary embodiment shown in FIG. 6, some of the incident light exits through the holes of the light controllers 140, thereby minimizing loss of the incident light.

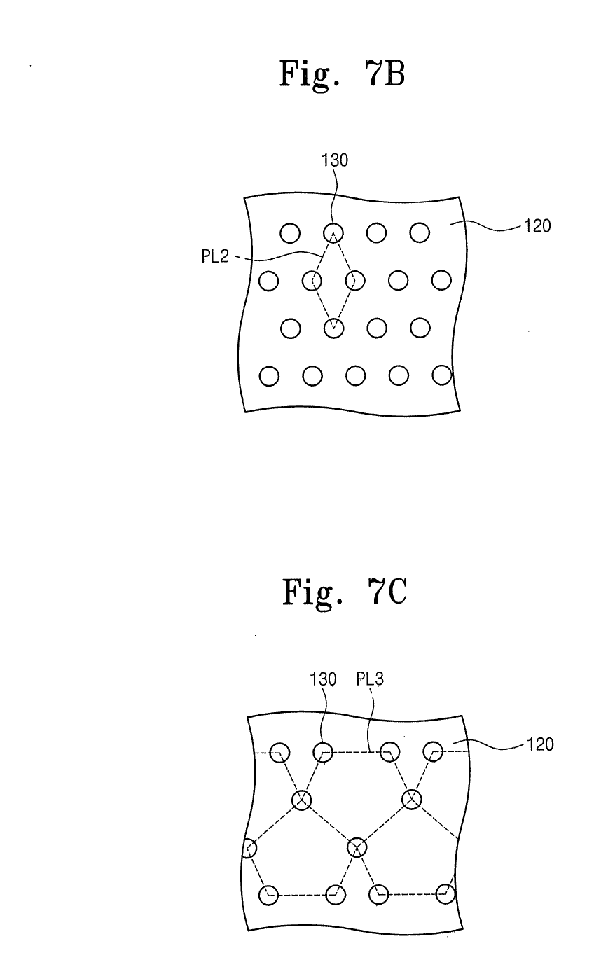

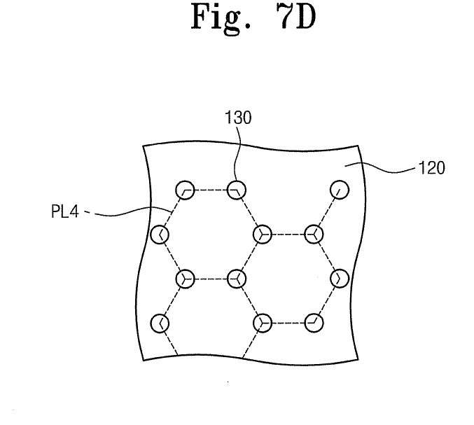

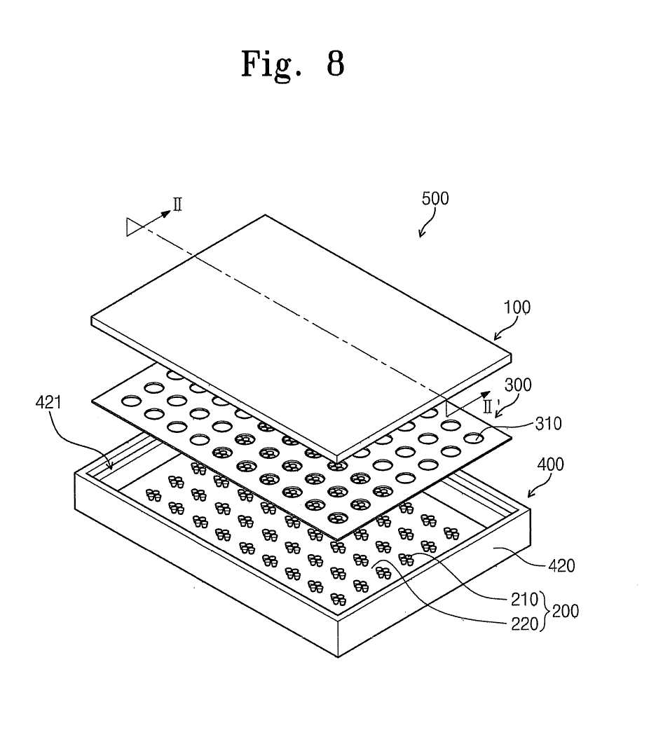

FIGS. 7A to 7D are plan views illustrating alignment patterns of the light controllers shown in FIG. 1.

Referring to FIGS. 7A to 7D, the plurality of light controllers 130 may be arbitrarily arranged or may be arranged in specific patterns.

As illustrated in FIG. 7A, a line PL1 that connects adjacent four light controllers 130 to each other may have a square shape. As illustrated in FIG. 7B, a line PL2 that connects adjacent four light controllers 130 to each other may have a diamond shape.

Also, as illustrated in FIG. 7C, a line PL3 that connects adjacent five light controllers to each other may be pentagonal in shape. As illustrated in FIG. 7D, a line PL4 that connects adjacent six light controllers to each other may have a hexagonal shape.

It will be understood that the above-referenced alignment patterns may be applied to an optical member employing light controllers 140 (e.g., the optical member shown in FIG. 6).

Referring again to FIG. 1, in the present exemplary embodiment, the optical member 100 may include a diffusing pattern, a plurality of beads, and/or a plurality of voids to diffuse the incident light. The diffusing pattern is formed on the bottom surface 120, and the beads and voids are formed between the top surface 110 and the bottom surface 120.

Hereinafter, a backlight assembly employing the optical member 100 will be described in detail with reference to the drawings.

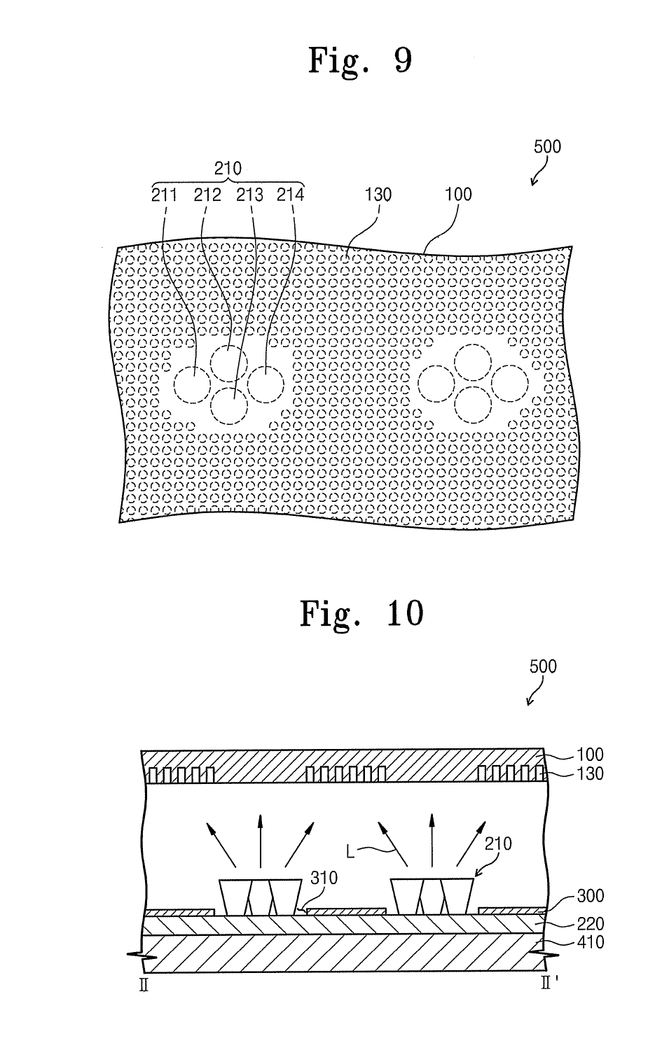

FIG. 8 is an exploded perspective view illustrating an exemplary embodiment of the backlight assembly according to the present invention, and FIG. 9 is a plan view illustrating the backlight assembly shown in FIG. 8.

Referring to FIGS. 8 and 9, a backlight assembly 500 includes a light generator 200 receiving a power to generate light, the optical member 100 diffusing the light received from the light generator 200, and a receptacle 400 accommodating the light generator 200 therein.

The light generator 200 includes a plurality of light source groups 210 generating the light and a circuit board 220 on which the light source groups 210 are mounted.

The light source groups 210 are separated from each other by a predetermined distance to receive the power through the circuit board 220 and to emit the light. A light source group 210 includes a light source 211 emitting red light, two light sources 212 and 213 emitting green light, and a light source 214 emitting blue light.

According to the present embodiment, the light source groups 210 emit red, green, and blue light components. However, it will be understood that the number of colors of the light emitted from the light source groups 210 can be increased or decreased.

Also, as shown in FIG. 9, the light source group 210 includes four light sources 211-214. However, the number of light sources may be increased or reduced in accordance with the size of the backlight assembly 500. Also, the number of light sources corresponding to each monochromatic light component may be increased or decreased.

The light sources 211, 212, 213, and 214 include point light sources, for example, light emitting diodes (“LEDs”) and are fixed to the circuit board 220.

The circuit board 220 may be a thin substrate upon which power source lines (not shown) supplying the power source are formed. The circuit board 220 includes a printed circuit board (“PCB”) or a metal coating printed circuit board (“MCPCB”) obtained by coating a PCB with a metal having high heat conductivity. The light source group 210 receives the power through the power source lines formed on the circuit board 220 to emit the red, green, and blue light components.

FIG. 10 is a cross-sectional view of the backlight assembly 500 of FIG. 8 taken along a line II-II′.

Referring to FIGS. 9 and 10, the optical member 100 is provided above the light source groups 210. Since the optical member 100 has the same structure as that of the optical member 100 illustrated in FIGS. 1 to 3, detailed description thereof will be omitted.

The optical member 100 is separated from the light source groups 210 to provide a space into which the light L generated from the light source groups 210 can be diffused, to mix the colors of the light L with each other, and to output the mixed color. In particular, the light controllers 130 formed in the optical member 100 refract the light L incident from the light source groups 210 to mix and diffuse the light L from the light source groups 210.

A ratio of a length of each light controller to a thickness of the optical member 100 is from about 0.7:1 to about 1:1, and a ratio of a width of each light controller to the thickness of the optical member 100 is from about 0.15 to about 1.

For example, the thickness of the optical member 100 is about 2 mm, the length of each light controller is from about 1.4 mm to about 2 mm, and the width of each light controller is about 0.3 mm.

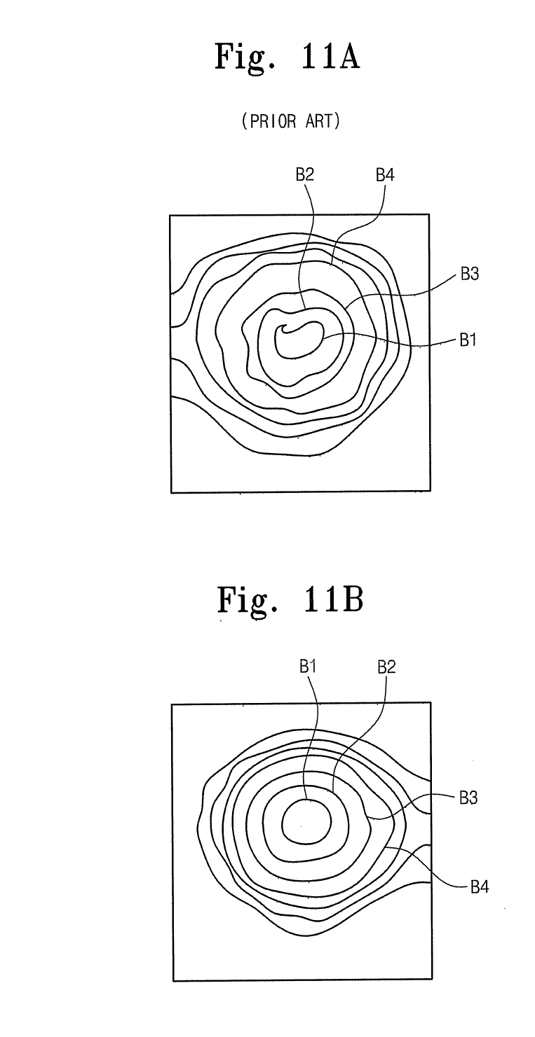

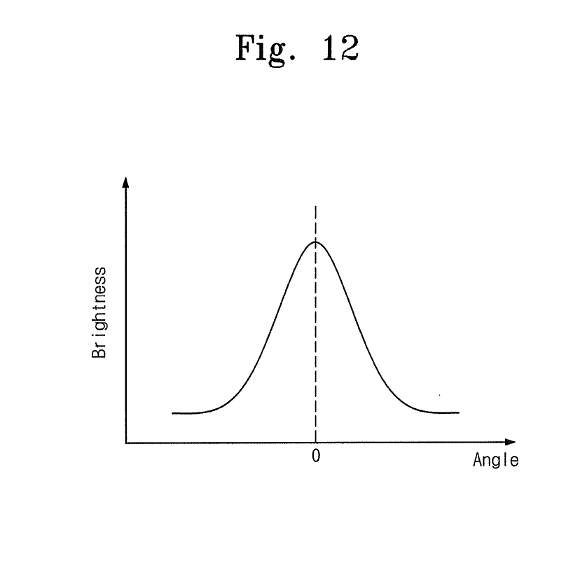

FIG. 11A is a simulation view illustrating brightness intensity of a conventional optical sheet, and FIG. 11B is a simulation view illustrating brightness intensity of the optical member of FIG. 7. FIG. 12 is a graph illustrating brightness distribution of the light sources shown in FIG. 8.

FIG. 111A is a simulation view illustrating the brightness distribution of a region corresponding to the light source groups 210 in the conventional optical sheet, and FIG. 11B is a simulation view illustrating the brightness distribution of a region corresponding to the light source groups 210 in the optical member 100 shown in FIG. 7.

As shown in FIGS. 11A and 11B, the first brightness region B1 having higher brightness is widely formed in the optical member 100 than that of the conventional optical sheet. That is, since the light controllers 130 are formed by removing portions of the optical member 100, the light loss factor of the optical member 100 is lower than that of the conventional optical sheet. As a result, the brightness of the optical member 100 is higher than the brightness of the conventional optical sheet.

Referring to FIGS. 9, 10, and 12, since the light controllers 130 reduce the light loss factor to increase the brightness, when viewed in a plan view, the light controllers 130 are provided at the outside of the light source groups 210 to improve the brightness uniformity of the backlight assembly 500.

The brightness of the light sources 211, 212, 213, and 214 is reduced at a region between the light sources 211, 212, 213, and 214 as compared to a region in which the light source group 210 is positioned. Since the brightness of the region in which the light source group 210 is positioned is higher than the brightness of the peripheral region of the light source group 210 (e.g., the region in between the light source groups), a difference in brightness results between the region in which the light source group 210 is positioned and the peripheral region. In order to minimize this difference in brightness, the light controllers 130, when viewed in a plan view (e.g., the embodiment shown in FIG. 9), are positioned at the outside of the light source group 210 to improve the brightness of the peripheral region of the light source group 210. As a result, the overall brightness of the backlight assembly 500 is improved and the brightness uniformity and the color uniformity are improved. Also, since the backlight assembly 500 does not need an additional sheet (e.g., diffusion sheet) in order to improve the brightness uniformity and the color uniformity, manufacturing costs can be reduced.

Further, the optical member 100 diffuses and mixes the light from the light source groups 210 to improve the color uniformity and the brightness uniformity, thereby preventing color irregularity caused by brightness difference between the light sources 211, 212, 213 and 214. Thus, the light source group 210 may employ low-priced LEDs as the light sources 211, 212, 213 and 214, so that the manufacturing costs can be further reduced.

Referring again to FIGS. 8 and 10, the backlight assembly 500 further includes a reflection plate 300 reflecting the light that leaks from the light sources 211, 212, 213, and 214. The reflection plate 300 is disposed on the circuit board 220 and may be formed with plurality of insertion holes 310 into which the light source groups 210 are inserted. In an exemplary embodiment, the light source groups 210 are positioned on the reflection plate 300 through the insertion holes 310.

The optical member 100 and the light generator 200 are accommodated in the receptacle 400. The receptacle 400 includes a bottom surface 410 and a side wall 420 extending from the bottom surface 410 to form a receiving space. The light generator 200 is settled on the bottom surface 410. A stepped portion 421 is formed in the side wall 420 so that the optical member 100 can be settled in the receptacle 400.

Hereinafter, an LCD including the backlight assembly 500 will be described in detail with reference to the drawings.

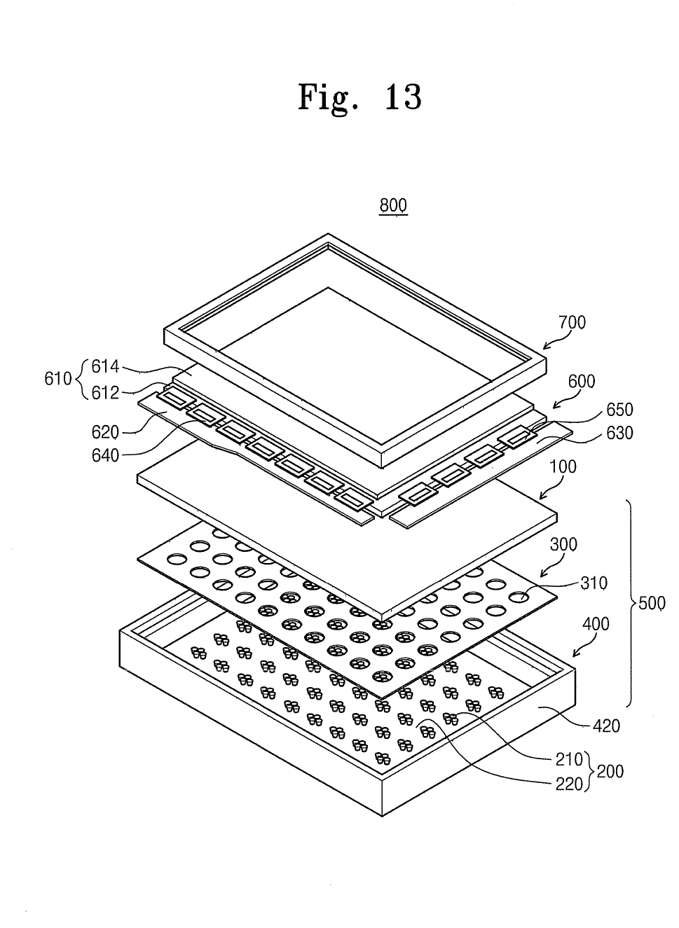

FIG. 13 is an exploded perspective view showing the LCD according to an exemplary embodiment of the present invention.

Referring to FIGS. 1 and 13, the LCD 800 includes the backlight assembly 500, a panel assembly 600, and a top chassis 700.

Since the backlight assembly 500 has same function and structure as those of the backlight assembly 500 illustrated in FIG. 8, detailed description thereof will be omitted.

The backlight assembly 500 includes the optical member 100, the light generator 200, the reflection plate 300, and the receptacle 400. The optical member 100 includes the light controllers 130 diffusing and mixing the light from the light generator 200. Since the backlight assembly 500 provides light having improved brightness uniformity and color uniformity to the panel assembly 600, a display characteristic is improved.

The panel assembly 600 is disposed above the backlight assembly 500. The panel assembly 600 includes an LCD panel 610 including two substrates 612 and 614 combined with each other to display an image, a data PCB 620 supplying data driving signals to the LCD panel 610, a gate PCB 630 supplying gate driving signals to the LCD panel 610, a data tape carrier package (“TCP”) 640 electrically connecting the data PCB 620 to the LCD panel 610, and a gate TCP 650 electrically connecting the gate PCB 630 to the LCD panel 610.

The top chassis 700 guides the position of the LCD panel 610 and is combined with the receptacle 400 to fix the LCD panel 610 to the receptacle 400.

According to the exemplary embodiments of the present invention the optical member includes the light controllers, which are formed by removing portions of the optical member, to diffuse and mix the light incident from the light source. Thus, the backlight assembly can improve the entire brightness as well as the brightness uniformity and the color uniformity, so that white light having high brightness with uniform brightness is provided to the LCD panel and the display characteristic is improved.

In addition, since the backlight assembly does not need an additional diffusion sheet in order to improve the brightness uniformity and the color uniformity, manufacturing costs thereof can be reduced.

Also, since the optical member can prevent the brightness from being non-uniform due to deviation in the brightness of the light sources, the backlight assembly can use low-priced LEDs that exhibit severe brightness deviation, so that manufacturing costs thereof can be reduced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An optical member comprising:
a bottom surface upon which light is incident from an outside source;
a top surface, facing the bottom surface, from which the incident light through the bottom surface exits; and
a plurality of light controllers formed between the bottom surface and the top surface by removing portions of the optical member to mix and diffuse the incident light,
wherein a ratio of a length of each light controller to a thickness of the optical member is from about 0.7:1 to about 1:1, and a ratio of a width of each light controller to the thickness of the optical member is from about 0.15 to about 1.

2. A backlight assembly comprising:
a light generator generating light; and
an optical member positioned above the light generator, the optical member including a plurality of light controllers formed between a bottom surface and a top surface of the optical member by removing portions of the optical member to mix and diffuse incident light, the light controllers refracting the incident light to change a path of the incident light.

3. The backlight assembly of claim 2, wherein the light controllers define holes formed through the bottom surface and the top surface, the light controllers refracting the incident light to change a path of the incident light.

4. The backlight assembly of claim 2, wherein a ratio of a length of each light controller to a thickness of the optical member is from about 0.7:1 to about 1:1, and a ratio of a width of each light controller to the thickness of the optical member is from about 0.15 to about 1.

5. The backlight assembly of claim 2, wherein the light generator comprises a plurality of light sources emitting the light having different colors from each other.

6. The backlight assembly of claim 5, wherein the light sources comprise light emitting diodes (LED).

7. The backlight assembly of claim 6, wherein the light controllers are positioned at a peripheral region of the light sources, when viewed in a plan view.

8. The backlight assembly of claim 7, wherein a number of the light controllers are disposed on the bottom surface of the optical member to form at least one pattern of a diamond shape pattern, a pentagonal shape pattern, and a hexagonal shape pattern.

9. The backlight assembly of claim 5, wherein the light sources are divided into a plurality of light source groups separated from each other by a predetermined distance, and each of the light source groups comprises at least one red light source, at least one green light source, and at least one blue light source.

10. The backlight assembly of claim 9, wherein the light controllers are positioned at a peripheral region of the light source groups, when viewed in a plan view.

11. The backlight assembly of claim 2, wherein the optical member comprises at least one pattern of a diffusing pattern, a plurality of beads, and a plurality of voids to diffuse the incident light.

12. A display apparatus comprising:
a backlight assembly including a light generator generating light and an optical member positioned above the light generator, the optical member including a plurality of light controllers formed between a bottom surface and a top surface of the optical member by removing portions of the optical member to mix and diffuse the light; and
a display panel disposed above the optical member to display an image using diffused light from the optical member.

13. The display apparatus of claim 12, wherein the light controllers define holes formed through the bottom surface and the top surface.

14. The display apparatus of claim 13, wherein the light generator comprises a plurality of point light sources.

15. The display apparatus of claim 14, wherein the light controllers are positioned at a peripheral region of the point light sources, when viewed in a plan view.

16. The display apparatus of claim 15, wherein a number of the light controllers are disposed on the bottom surface of the optical member to form at least one pattern of a diamond shape pattern, a pentagonal shape pattern, and a hexagonal shape pattern.

17. The display apparatus of claim 12, wherein the optical member comprises at least one pattern of a diffusing pattern, a plurality of beads, and a plurality of voids to diffuse the incident light.

18. A method of manufacturing a backlight assembly, comprising:
forming an optical member having a bottom surface upon which light is incident and a top surface facing the bottom surface from which the incident light through the bottom surface exits;
disposing the optical member above a light generator, the light generator generating the light; and
forming a plurality of light controllers between the bottom surface and top surface by removing portions of the optical member to mix and diffuse the light.

19. The method of claim 18, wherein forming a plurality of light controllers includes defining holes through the bottom surface and the top surface, the light controllers refracting the incident light to change a path of the incident light.

20. The method of claim 18, wherein a ratio of a length of each light controller to a thickness of the optical member is from about 0.7:1 to about 1:1, and a ratio of a width of each light controller to the thickness of the optical member is from about 0.15 to about 1.

21. The method of claim 18, wherein the light generator includes a plurality of light sources that emit red, green, and blue light components, the method further comprising:
disposing the light controllers on the optical member at a peripheral region of the light sources.

22. The method of claim 21, wherein a number of the light controllers are disposed on the bottom surface of the optical member to form at least one pattern of a diamond shape pattern, a pentagonal shape pattern, and a hexagonal shape pattern.

23. The method of claim 18, wherein the optical member comprises at least one pattern of a diffusing pattern, a plurality of beads, and a plurality of voids to diffuse the incident light.
